(19) United States
(12) Patent Application Publication
(10) Pub. No.: US 2025/0219802 A1
(43) Pub. Date: Jul. 3, 2025

(54) REDUCING RECEIVER DESENSITIZATION FOR FREQUENCY DIVISION DUPLEX BANDS USING BANDWIDTH PARTS

(71) Applicant: Lenovo (Singapore) Pte. Limited, Singapore (SG)

(72) Inventor: COLIN FRANK, Park Ridge, IL (US)

(21) Appl. No.: 18/850,005

(22) PCT Filed: Mar. 30, 2023
(86) PCT No.: PCT/IB2023/053211

§ 371 Date: Sep. 23, 2024

Related U.S. Application Data
(60) Provisional application No. 63/326,259, filed on Mar. 31, 2022.

(51) Int. Cl. H04L 5/00; H04B 1/10; H04B 1/525; H04L 5/14

(52) U.S. Cl. CPC H04L 5/0094; H04B 1/10; H04B 1/525; H04L 5/143

(57) ABSTRACT

Various aspects of the present disclosure relate to reducing transmit power leakage between a transmitter and a receiver of a transceiver of a user communication device that interferes with receiver sensitivity during wireless communication. A communication manager of the user communication device receives configuration data for configuring a transmit carrier bandwidth into multiple bandwidth parts. The communication manager selects a bandwidth part from among multiple bandwidth parts for use during uplink transmission. The communication manager configures the transceiver to use the first bandwidth part for uplink transmission. Use of the bandwidth part reduces leakage of transmit power from the transmitter into the receiver, reducing interference with the receiver. The base node may determine to implement an enhanced receiver sensitivity configuration at the user communication device, triggering the use of the bandwidth part.

### RELATED APPLICATION

This Application claims priority to U.S. Provisional Application No. 63/326,259, filed Mar. 31, 2022, the contents of which are fully incorporated herein.

### TECHNICAL FIELD

The present disclosure relates to wireless communications, and more specifically to devices that transmit and receive on adjacent spectra.

### BACKGROUND

A wireless communications system may include one or multiple network communication devices, such as base nodes, which may be otherwise known as an eNodeB (eNB), a next-generation NodeB (gNB), or other suitable terminology. Each network communication devices, such as a base node may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

User equipments communicate with network communication devices using frequency division duplex having a transmit spectrum separated from a receive spectrum by a duplex gap. A duplex filter band generally passes a transmit carrier within the transmit spectrum and band passes a receive carrier within the receive spectrum. A stop band of the duplex filter attenuates but does not wholly block signals in the duplex gap especially when the duplex gap is narrow. During transmission, transmit power leaks into the receiver of the user equipment causing receiver interference and degrading receiver performance.

### SUMMARY

The present disclosure relates to methods, apparatuses, and systems that support wireless communication at a communication device using bandwidth parts in order to avoid receiver desensitization due to transmitter noise for frequency division duplex bands. The present disclosure relates to methods, apparatuses, and systems that support wireless communication at a communication device using bandwidth parts in order to avoid receiver desensitization due to transmitter noise for frequency division duplex bands. According to one or more aspects, transmit power leakage is further reduced by one or more additional mitigations. First, a local oscillator for the transmitter is located within the bandwidth part, reducing a frequency span of signals that arise during modulation. In an example, the location of the local oscillator may be centered within the bandwidth part. Second, a transmit filter is selected that has a smallest possible bandwidth while still containing the bandwidth part. Third, the transmit filter is located in frequency as far away from receive spectrum as possible while still containing the bandwidth part. Fourth, narrower bandwidth parts are located closer to receive spectrum than wider bandwidth parts. By mitigating receiver desensitization from transmit power leakage, the communication device is able to operate in scenarios where receiver power margin is small and/or a duplex gap between transmit spectrum and the receive spectrum is small. A capability of the communication device to use bandwidth parts to meet enhanced receiver sensitivity requirements may be indicated to a network.

Some implementations of the method and apparatuses described herein may further include the communication device receiving configuration data for configuring a transmit carrier bandwidth into multiple bandwidth parts. A communication manager of the communication device selecting, by a communication manager of the communication device, a first bandwidth part from among the multiple bandwidth parts for use during uplink transmission. The implementation further includes configuring a transceiver of the communication device to use the first bandwidth part for uplink transmission, in order to reduce leakage of transmit power from a transmitter into a receiver, and to reduce interference with the receiver.

The present disclosure also relates to methods, apparatuses, and systems that support wireless communication at a base node that include receiving bandwidth part capability data from a user communication device communicatively connected to a transceiver of the base node. Knowing that the user communication is capable of using bandwidth parts enables the base node to configure the user communication device for improved receiver sensitivity.

Some implementations of the method and apparatuses described herein may further include that the base node determines, in response to receiving the bandwidth part capability data, at least one first bandwidth part having a bandwidth and a location within a transmit carrier bandwidth that reduces interference from a transmitter of the communication device into a receiver of the communication device. The base node encodes a configuration signal with an assignment of bandwidth parts to the communication device in order to reduce receiver desensing from interference caused by a transmitter power. The base node transmits, by the transceiver, the configuration signal to the communication device to cause the communication device to configure the bandwidth parts on the transmit carrier bandwidth and select a first bandwidth part for transmissions to reduce the receiver desensing.

Some implementations of the method and apparatuses described herein may further include identifying that the capability data includes a capability of the communication device to select a transmit filter from among more than one transmit filters provided by the communication device and to modify a bandwidth and a filter location of the selected transmit filter. The implementation further includes encoding, within the configuration signal, control commands to configure the communication device to (i) select a transmit filter with a transmit filter bandwidth that is less than a transmit carrier bandwidth and that encompasses the bandwidth part; (ii) selectively reduce the transmit filter bandwidth to a smallest allowed carrier bandwidth that contains the first bandwidth part; (iii) move a location of the transmit filter to a filter location in which the transmit filter bandwidth includes a complete bandwidth part bandwidth.

Some implementations of the method and apparatuses described herein may further include the base node, in response to detecting a connection to the base node by a user communication device determining to implement an enhanced receiver sensitivity configuration at the user communication device. A transceiver of the base node autonomously transmits a configuration signal to the communication device to configure the user communication device to: (i) configure bandwidth parts on a transmit carrier bandwidth of the transmit carrier; (ii) select a first bandwidth part and a transmit filter for transmissions via the first bandwidth part in order to reduce receiver desensing at the user communication device; and (iii) select a location of one or both of a local oscillator and the transmit filter if the communication device supports modification of the location.

### BRIEF DESCRIPTION OF THE DRAWINGS

FIG. 1 illustrates an example of a wireless communications system that supports reducing leakage of transmit power from a transmitter into a receiver of a user communication device to reduce interference with the at least one receiver, in accordance with aspects of the present disclosure.

FIG. 2 depicts a frequency structure of a frequency division duplex (FDD) band that is modified using bandwidth parts to a frequency structure that mitigates receiver desensitization, in accordance with aspects of the present disclosure.

FIG. 3 illustrates plots of the frequency response of using bandwidth parts of different bandwidth and with different filter bandwidths in accordance with aspects of the present disclosure.

FIGS. 4A through 4C are example frequency structures of a transmit local oscillator located centrally, in a lower frequency portion, and a higher frequency portion in a bandwidth part, in accordance with aspects of the present disclosure.

FIGS. 5A through 5C are example configurations of a transmit filter respectively centered on a bandwidth part, centered on a local oscillator within the bandwidth part, and shifted as far as possible away from the receive spectrum while still containing the bandwidth part, in accordance with aspects of the present disclosure.

FIG. 6 illustrates an example of a block diagram of a device that supports reducing leakage of transmit power from a transmitter into a receiver of the device by using bandwidth parts, in accordance with aspects of the present disclosure.

FIG. 7 illustrates an example of a block diagram of a network device that supports configuring a user communication device to utilize bandwidth parts with operating parameters that reduces/mitigates receiver interference at the user communication device, in accordance with aspects of the present disclosure.

FIGS. 8 through 10 illustrate flowcharts of methods that support reducing leakage of transmit power from a transmitter into a receiver of a user communication device by using bandwidth parts, in accordance with aspects of the present disclosure.

### DETAILED DESCRIPTION

For Frequency Division Duplex (FDD) bands in wireless communication, the performance of a receiver can be degraded by power leakage from a transmitter of a communication device if the frequency spectrum used for transmission is too close to the frequency spectrum used for reception. In general, the degradation of the receiver performance is a function of several parameters: (i) the duplex gap; (ii) the duplex spacing; (iii) the bandwidth of the carrier; and (iv) the transmitter power.

The receiver reference sensitivity can be defined as the power that must be received at the UE in order for the UE to successfully receive a particular reference signal. For example, in the 5G standards, the reference sensitivity is defined as: “The reference sensitivity power level REFSENS is the minimum mean power applied to each one of the UE antenna ports for all UE categories, at which the throughput shall meet or exceed the requirements for the specified reference measurement channel.”

Table I below provides a portion of an example reference sensitivity requirements from which several observations can be made. In comparing the 5 MHz/SCS 15 kHz Refsens values for n1 and n3, it can be observed that 3 dB more power is required for band n3 than for n1. For a bandwidth of 50 MHz with 15 kHz SCS, it can be observed that 9.9 dB more power is required for n3 than for n1. The reason for this difference is that the duplex gap is much smaller for n3 than for n1, and as a result, there is much more leakage of power from the transmitter to the receiver.

TABLE I
Two antenna port reference sensitivity QPSK PREFSENS for FDD bands.
Operating band / SCS / Channel bandwidth

| | | 5 | 10 | 15 | 20 | 25 | 30 | 35 | 40 | 45 | 50 |
|---|---|---|---|---|---|---|---|---|---|---|---|
| Operating | SCS | MHz | MHz | MHz | MHz | MHz | MHz | MHz | MHz | MHz | MHz |
| Band | kHz | (dBm) | (dBm) | (dBm) | (dBm) | (dBm) | (dBm) | (dBm) | (dBm) | (dBm) | (dBm) |
| n1 | 15 | −100.0 | −96.8 | −95.0 | −93.8 | −92.7 | −91.9 | | −90.6 | −90.1 | −89.6 |
| | 30 | | −97.1 | −95.1 | −94.0 | −92.8 | −92.0 | | −90.7 | −90.2 | −89.7 |
| | 60 | | −97.5 | −95.4 | −94.2 | −93.0 | −92.1 | | −90.9 | −90.3 | −89.7 |
| n3 | 15 | −97.0 | −93.8 | −92.0 | −90.8 | −89.7 | −88.9 | −86.2 | −82.3 | −81.3 | −79.7 |
| | 30 | | −94.1 | −92.1 | −91.0 | −89.8 | −89.0 | −86.3 | −82.4 | −81.4 | −79.8 |
| | 60 | | −94.5 | −92.4 | −91.2 | −90.0 | −89.1 | −86.4 | −82.6 | −81.5 | −79.9 |

Table II below provides example operating band from which it can be observed that the duplex gaps for n1 and n3 are 130 MHz and 20 MHz, respectively. Thus, the transmit spectrum is much closer to the receive spectrum for band n3. Table III provides uplink configuration for reference sensitivity.

TABLE II
NR operating bands in FR1.

| NR | Uplink (UL) operating band | Downlink (DL) operating band | |
|---|---|---|---|
| operating | BS receive/UE transmit | BS transmit/UE receive | Duplex |
| band | F_{UL}_{_{—}}_{low}-F_{UL}_{_{—}}_{high} | F_{DL}_{_{—}}_{low}-F_{DL}_{_{—}}_{high} | Mode |
| n1 | 1920 MHz-1980 MHz | 2110 MHz-2170 MHz | FDD |
| n3 | 1710 MHz-1785 MHz | 1805 MHz-1880 MHz | FDD |

TABLE III
Uplink configuration for reference sensitivity.
Operating band / SCS (kHz) / Channel bandwidth (MHz) / Duplex mode

| Operating | | | | | | | | | | | | | | | | | Duplex |
|---|---|---|---|---|---|---|---|---|---|---|---|---|---|---|---|---|---|
| Band | SCS | 5 | 10 | 15 | 20 | 25 | 30 | 35 | 40 | 45 | 50 | 60 | 70 | 80 | 90 | 100 | Mode |
| n1 | 15 | 25 | 50¹ | 75¹ | 100¹ | 128¹ | 128¹ | | 128¹ | 128¹ | 128¹ | zzz | zzz | zzz | zzz | zzz | FDD |
| | 30 | | 24 | 36¹ | 50¹ | 64¹ | 64¹ | | 64¹ | 64¹ | 64¹ | | | | | | |
| | 60 | | 10¹ | 18 | 24 | 30¹ | 30¹ | | 30¹ | 30¹ | 30¹ | | | | | | |
| n3 | 15 | 25 | 50¹ | 50¹ | 50¹ | 50¹ | 50¹ | 50¹ | 50¹ | 50¹ | 50¹ | | | | | | FDD |
| | 30 | | 24 | 24¹ | 24¹ | 24¹ | 24¹ | 24¹ | 24¹ | 24¹ | 24¹ | | | | | | |
| | 60 | | 10¹ | 10¹ | 10¹ | 10¹ | 10¹ | 10¹ | 10¹ | 10¹ | 10¹ | | | | | | |

Note 1:
UL resource blocks shall be located as close as possible to the downlink operating band but confined within the transmission bandwidth configuration for the channel bandwidth (Table 5.3.2-1).

There are two types of filtering that protect the receiver spectrum from the transmitter noise. The first of these is the duplex filter. The duplex filter is implemented in hardware and thus cannot be modified once implemented. Because the duplex filter requires a transition region between the pass band and the stop band, the protection provided by the duplex filter will depend on the bandwidth of the given band and the size of the duplex gap. Because band n3 has a bandwidth of 75 MHz and a duplex gap of only 20 MHz, the performance of the n3 duplexer is very limited at the lower edge of the receive spectrum.

The second type of filter that protects the receiver spectrum from the transmitter noise is the baseband transmitter filter (“transmit filter”). The bandwidth of the transmit filter is scaled for the channel bandwidth of the carrier. Thus, the UE already has separate baseband filters defined for each of the allowed carrier bandwidths from 5 MHz up to 50 MHz.

It is often the case that the UE data requirements are asymmetric on the uplink and downlink, so that the data rate requirements are less on the uplink than on the downlink. Alternatively, there are times at the edge of coverage, where it is more important for the UE to maintain connectivity than to achieve maximum throughput. The current disclosure thus recognizes that, for both of these instances, the UE should reduce the bandwidth of the uplink allocations in order to reduce the leakage of transmit power into the receiver and thus improve receiver performance.

Accordingly, according to various aspects of the present disclosure, several different options are provided for reducing the transmitter leakage of transmit power into the receiver. These options include: (i) Option 1—The use of carrier aggregation in which fewer carriers are used on the uplink than the downlink; (ii) Option 2—The application of scheduling restrictions to limit the bandwidth and the proximity of the transmit resource allocations assigned to the UE relative to the UE's receive spectrum; (iii) Option 3—The use of bandwidth parts to limit the bandwidth and proximity of resource allocations assigned to the UE relative to the UE's receive spectrum; and (iv) Option 4—The use of bandwidth parts as in Option 3, with additional limitations on the location of the local oscillator (LO) and/or the bandwidth of the transmit filter used for the bandwidth part.

The use of carrier aggregation as in Option 1 to reduce receiver desensitization introduces overhead associated with carrier aggregation, including the use of additional control channels and synchronization channels. Additionally, there is overhead with adding and releasing the secondary physical channel on the uplink, since the UE may at times benefit in using the full uplink bandwidth.

The use of scheduling restrictions as in Option 2 provides a feasible method for reducing the interference from the UE transmitter into the UE receiver. With this option, the location of the UE local oscillator and the bandwidth of the UE transmit filter will be unchanged since the UE is unaware that the scheduling restriction is being applied. As a result, the UE's local oscillator will not be centered within the restricted region in which resource blocks may be allocated. Since the transmit filter cannot be changed every slot and/or subframe, and since the UE is unaware of the scheduling restriction being applied, the UE will use the transmit filter for the full carrier and will not reduce the bandwidth of the transmit filter to the restricted region.

Instead, aspects of the present disclosure provide wireless communication using bandwidth parts in order to avoid receiver desensitization due to transmitter noise for frequency division duplex bands. Transmit power leakage is further reduced by one or more additional mitigations. First, a local oscillator for the transmitter is located within the bandwidth part, reducing a frequency span of intermodulation product signals that arise during modulation due to nonlinearities in the transmitter. In an example, the location of the local oscillator may be centered within the bandwidth part. Second, a transmit filter is selected that has a smallest possible bandwidth while still containing the bandwidth part. Third, the transmit filter is located in frequency as far away from receive spectrum as possible while still containing the bandwidth part. Fourth, narrower bandwidth parts are located closer to receive spectrum than wider bandwidth parts. By mitigating receiver desensitization from transmit power leakage, the communication device is able to operate in scenarios where receiver power margin is small and/or a duplex gap between transmit spectrum and the receive spectrum is small. A capability of the communication device to use bandwidth parts to meet enhanced receiver sensitivity requirements may be indicated to a network.

Aspects of the present disclosure are described in the context of a wireless communications system. Aspects of the present disclosure are further illustrated and described with reference to device diagrams, flowcharts that relate to configuring and using baseband parts to mitigate transmitter power leakage from a transmitter to a receiver that otherwise would desense the receiver.

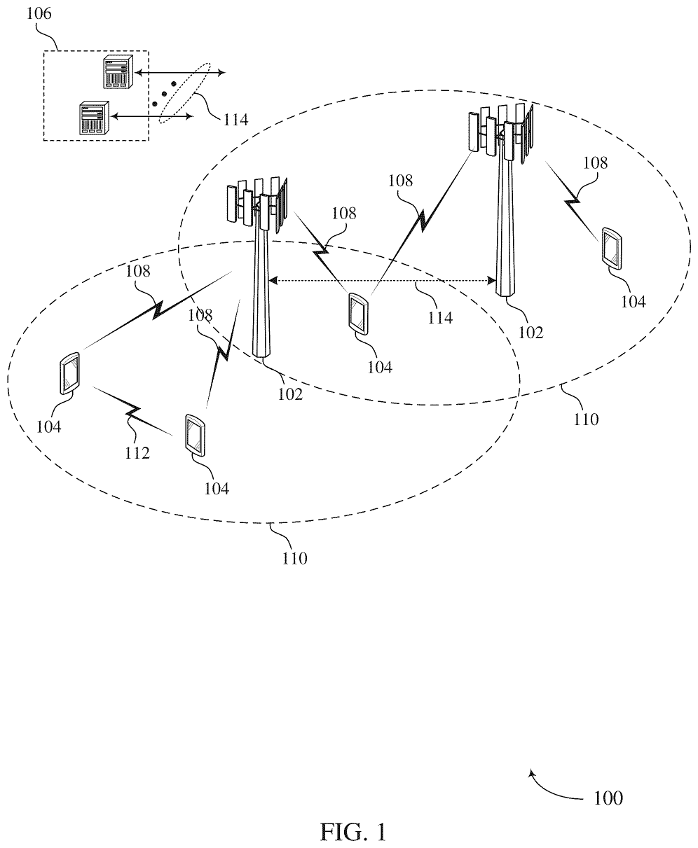

FIG. 1 illustrates an example of a wireless communications system 100 that supports wireless communication using bandwidth parts to reduce interference from a transmitter into a receiver that degrades reception in accordance with aspects of the present disclosure. The wireless communications system 100 may include one or more base nodes 102, one or more UEs 104, and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base nodes 102 may be dispersed throughout a geographic region to form the wireless communications system 100. One or more of the base nodes 102 described herein may be or include or may be referred to as a base transceiver station, an access point, a NodeB, an eNodeB (eNB), a next-generation NodeB (gNB), or other suitable terminology. A base node 102 and a UE 104 may communicate via a communication link 108, which may be a wireless or wired connection. For example, a base node 102 and a UE 104 may wireless communication over a Uu interface.

A base node 102 may provide a geographic coverage area 110 for which the base node 102 may support services (e.g., voice, video, packet data, messaging, broadcast, etc.) for one or more UEs 104 within the geographic coverage area 110. For example, a base node 102 and a UE 104 may support wireless communication of signals related to services (e.g., voice, video, packet data, messaging, broadcast, etc.) according to one or multiple radio access technologies. In some implementations, a base node 102 may be moveable, for example, a satellite associated with a non-terrestrial network. In some implementations, different geographic coverage areas 110 associated with the same or different radio access technologies may overlap, but the different geographic coverage areas 110 may be associated with different base nodes 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the base nodes 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base nodes 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base node 102 may support communications with the core network 106, or with another base node 102, or both. For example, a base node 102 may interface with the core network 106 through one or more backhaul links 114 (e.g., via an S1, N2, N2, or another network interface). The base nodes 102 may communication with each other over the backhaul links 114 (e.g., via an X2, Xn, or another network interface). In some implementations, the base nodes 102 may communicate with each other directly (e.g., between the base nodes 102). In some other implementations, the base nodes 102 may communicate with each other or indirectly (e.g., via the core network 106). In some implementations, one or more base nodes 102 may include subcomponents, such as an access network entity, which may be an example of an access node controller (ANC). An ANC may communication with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base nodes 102 associated with the core network 106.

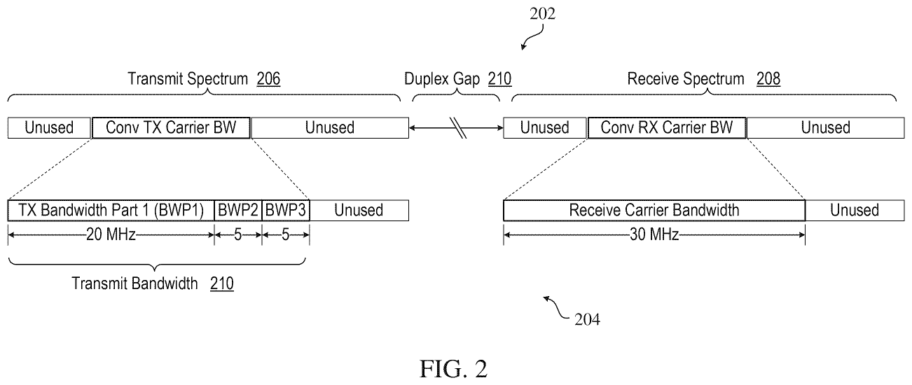

FIG. 2 depicts example frequency structure 202 of a frequency division duplex (FDD) band that is modified using bandwidth parts to frequency structure 204 that mitigates receiver desensitization. Both frequency structures 202 and 204 include two blocks of contiguous spectrum: transmit spectrum 206 and receive spectrum 208 separated by duplex gap 209. Duplex gap 209 is the distance in frequency from the top of the lower spectrum block to the bottom of the upper spectrum block. For some bands, transmit spectrum 206 is below receive spectrum 208 in frequency, while for other bands the transmit spectrum is above the receive spectrum. The duplex spacing is the distance in frequency between the center of the transmit carrier and the center of the receive carrier. The bandwidth of the transmit carrier (transmit bandwidth 210) is the distance in frequency between the bottom of the transmit carrier and the top of the transmit carrier. Similarly, the bandwidth of the receive carrier is the distance in frequency between the bottom of the receive carrier and the top of the receive carrier. In some embodiments, these two carrier bandwidths are equal, but in other embodiments the bandwidths can be different.

Frequency structure 204 depicts aspects of Options 3 and 4. In the illustrated embodiment, transmit bandwidth 210 is divided into three bandwidth parts, including a 20 MHz bandwidth part and two 5 MHz bandwidth parts. According to one aspect of the disclosure, associated with implementation of Options 3 and 4, the two 5 MHz bandwidth parts are placed at the bottom of the carrier, closest to the receive carrier. Due to their limited bandwidth, a UE that is assigned to one of these 5 MHz bandwidth parts will generate much less interference into its downlink receiver than a UE which transmits on a resource block allocation which occupies the entire carrier bandwidth or one that transmits on the larger 20 MHz bandwidth part.

According to one aspect involving the use of bandwidth parts in Option 3, there is no restriction on the location of the local oscillator of the transmitter or on the bandwidth of the transmit filter. As a result, the performance is fundamentally the same as with the use of scheduling restrictions. However, because the UE is aware of the bandwidth part, the UE may optionally move the location of the UE's local oscillator to the center of the bandwidth part in order to minimize the span of the resulting intermodulation products due to transmitter nonlinearities and minimize interference into its receiver. Similarly, the UE may optionally reduce the bandwidth of the UE's transmit filter to some value that is less than the bandwidth of the transmit carrier but greater than the bandwidth of the smaller-bandwidth bandwidth part in order to minimize the interference into the receiver.

According to another aspect involving the use of bandwidth parts in Option 4, the UE would be configured to provide a limitation placed on the location of the UE local oscillator with respect to the bandwidth part. Also, the UE would be configured to use the transmit filter corresponding to the smallest carrier bandwidth that contains the bandwidth part. Alternatively, in one or more embodiments, the UE would be configured to select and use a transmit filter with bandwidth that is smaller than the bandwidth of the transmit filter corresponding to the smallest carrier bandwidth, so long as the bandwidth of the selected transmit filter is wider than and contains/encompasses the bandwidth part.

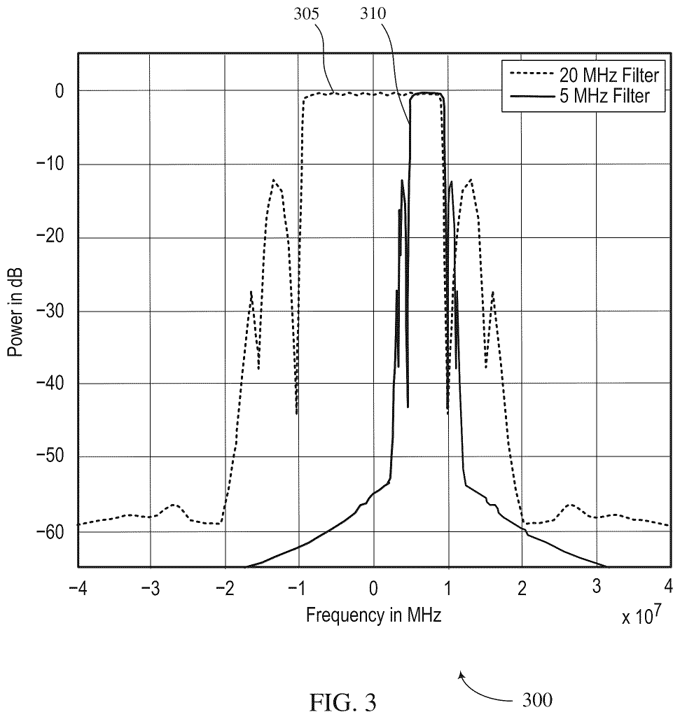

The benefits of using the smaller transmit filter are illustrated in FIG. 3, described below, in which the frequency response of the 5 and 20 MHz transmit filters (of FIG. 2) are shown. FIG. 3 depicts plots 300 of frequency responses 305 and 310 respectively of 20 MHz and 5 MHz channel filters. From the different plots, and observation can be made that by using the 5 MHz filter for a 5 MHz bandwidth part at the edge of a 20 MHz carrier, the power leakage into the adjacent channel will be greatly reduced relative to the leakage that would occur with the use of the 20 MHz filter. This reduction in the power leakage is due to the faster roll-off of the 5 MHz filter.

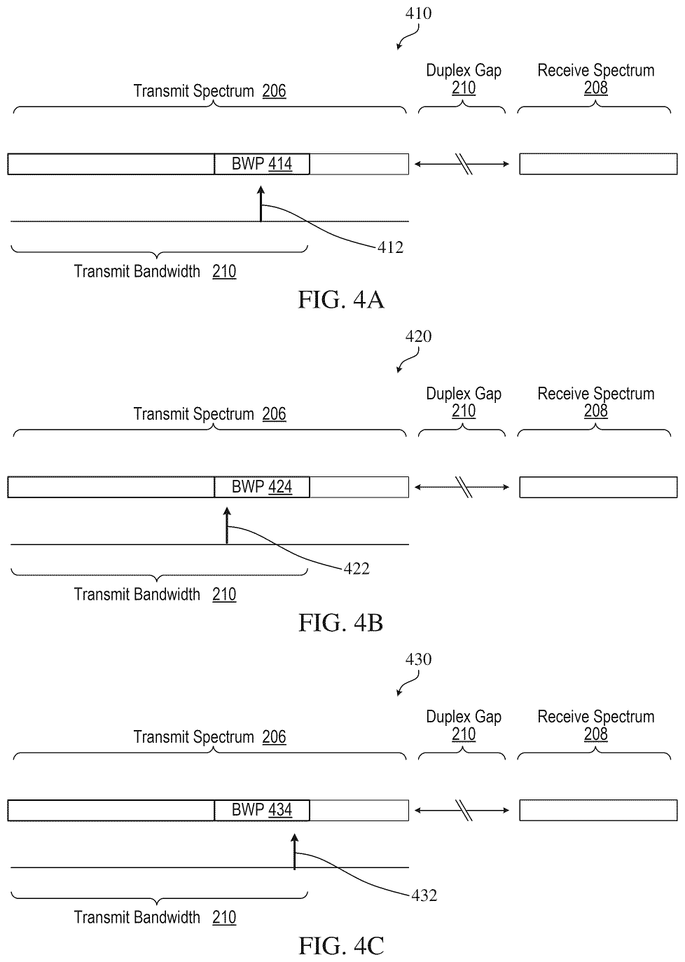

FIG. 4A is an example frequency structure 410 of a transmit local oscillator 412 centrally located in bandwidth part 414. FIG. 4B is an example frequency structure 420 of a transmit local oscillator 422 located on a lower frequency portion of a bandwidth part 424. FIG. 4C is an example frequency structure 430 of a transmit local oscillator 432 located on a lower frequency portion of a bandwidth part 434. With the implementation of Option 4, the UE is provided with multiple alternatives in determining the location of the LO relative to the bandwidth part. In general, as provided at FIG. 4A, the LO can be located at a central point of the bandwidth part. Analysis of the resulting characteristics with the LO centrally placed relative to the bandwidth part indicates that this placement may be best in order to minimize the span of the intermodulation products resulting from transmitter non-linearities such as the power amplifier (PA) non-linearities. However, according to other embodiments, generally illustrated by FIGS. 4B-4C, placement of the LO anywhere (e.g., towards the left or right) within the bandwidth part may be sufficient, depending on the reference sensitivity requirement for the bandwidth part.

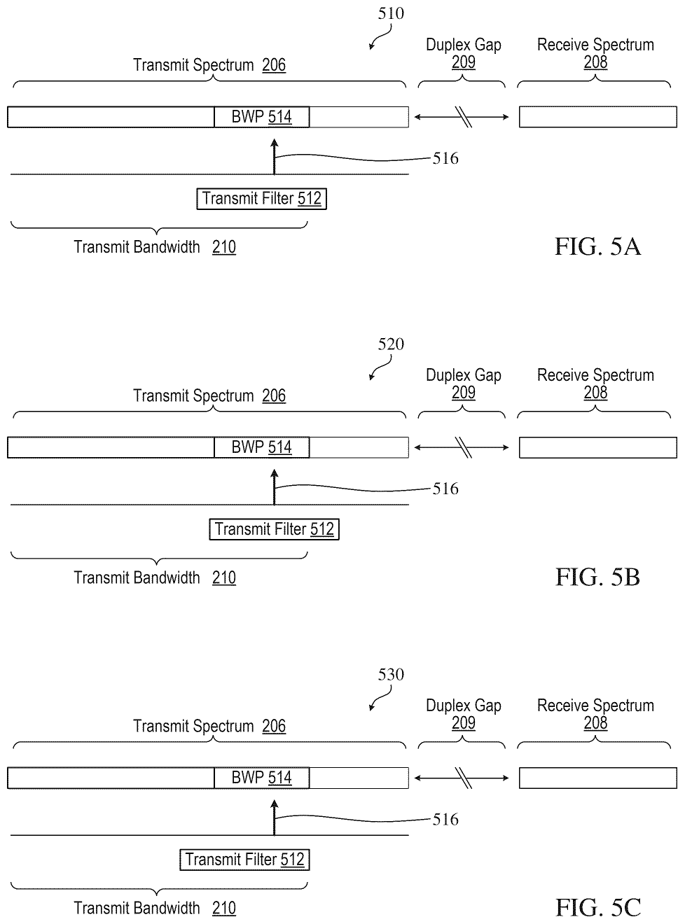

FIG. 5A is an example configuration 510 of a transmit filter 512 centered on a bandwidth part 514. Local oscillator 516 is located within bandwidth part 514. FIG. 5B is an example configuration 520 of a transmit filter 512 centered on the local oscillator 516 within the bandwidth part 514. FIG. 5C is an example configuration 530 of the transmit filter 512 shifted as possible away from receive spectrum 208 while still containing the bandwidth part 514. Additionally, with the embodiments of Option 4, which require that the smaller bandwidth transmit filter be used with the bandwidth part, several different alternatives are provided for placement of the smaller bandwidth transmit filter relative to the bandwidth part. These alternatives include: (i) center the smaller bandwidth transmit filter on the center of the bandwidth part (FIG. 5A); (ii) center the smaller bandwidth transmit filter on the local oscillator within the bandwidth part (FIG. 5B); (iii) shift the smaller bandwidth transmit filter so that the edge of the filter is as far as possible from the receive spectrum while still containing the bandwidth part (FIG. 5C). Notably, according to one important aspect, irrespective of the placement of the smaller bandwidth transmit filter, the bandwidth of the transmit filter must be sufficient to include the entire bandwidth of the bandwidth part, with the given placement of the transmit filter.

Referring to Tables I and II, the reference sensitivity values defined in Table I all have corresponding uplink resource block configurations in Table III. For larger carrier bandwidths, the uplink resource block configuration is often much less than the maximum that is allowed for the given carrier bandwidth. This uplink resource block allocation is typically placed as close as possible to the downlink carrier while staying within the uplink carrier bandwidth. According to one aspect, in order to determine new requirements for bandwidth parts with or without restrictions on the local oscillator location and on the bandwidth of the transmit filter, the reference sensitivity is evaluated for these same uplink resource allocations. Additionally, bandwidth part bandwidths and locations within the carrier bandwidth for which the interference from the transmitter into the receiver is minimal is evaluated so that the UE receiver performance can be protected when the UE is transmitting at full power. With this information, the gNB scheduler (704) can assign bandwidth parts to the UE in a manner which minimizes the reference sensitivity.

It is appreciated that not all UE's may have the capability to place the local oscillator either within the bandwidth part or at the center of the bandwidth part. Similarly, not all UE's may have the ability to reduce the bandwidth of the transmit filter for the bandwidth part. According to one or more embodiments, the UE that is configured with the capability to move/place the LO relative to the bandwidth part is programmed to indicate bandwidth part capability data within the registration request message a capability to place the local oscillator either within the bandwidth part or in the center of the bandwidth part. Similarly, according to one or more embodiments, the UE that is configured with the capability to reduce the bandwidth of the transmit filter when transmitting a bandwidth part is programmed to indicate within the registration request message a capability to reduce the bandwidth of the transmit filter when transmitting a bandwidth part. Alternatively, in one or more embodiments, additional enhanced messaging requirements can be provided for UE's that can center the local oscillator within the bandwidth part and UEs that can reduce the bandwidth of the transmit filter to the bandwidth of the smallest allowed carrier bandwidth which contains the bandwidth part. In embodiments in which such enhance requirements are defined for the UE, the UE may indicate within the registration request message the capability to meet the enhanced requirements. The network device responds to the receipt of these capability indications by selecting appropriate bandwidth parts to assign to the UE for uplink transmission in order to minimize receiver interference.

According to one aspect of the present disclosure, a method performed by a UE includes receiving the configuration of a bandwidth part for transmission. The method includes activating the bandwidth part for transmission. The method includes meeting an enhanced receiver sensitivity requirement. In one or more embodiments, the method further includes moving the transmitter local oscillator to the center of the bandwidth part. In one or more embodiments, the method includes reducing the bandwidth of the transmit filter.

According to another aspect of the present disclosure, a method performed by a base node (gNB) includes receiving a capability indication from a UE. The method includes configuring the UE with a bandwidth part for transmission. In one or more embodiments, the method includes configuring the UE in response to determining that an enhanced receiver sensitivity requirement applies at the UE. In one or more embodiments, the enhanced receiver requirement depends on whether the UE capability indicator indicates that the UE centers the location of the transmitter local oscillator within the bandwidth part. In one or more particular embodiments, the enhance receiver requirement depends on whether the UE capability indicator indicates the UE reduces the bandwidth of its baseband transmit filter.

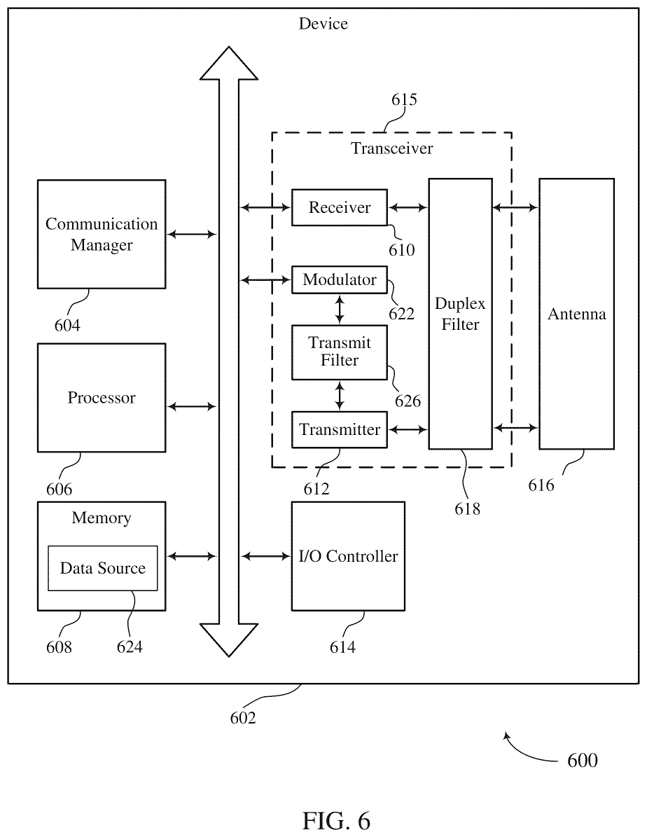

FIG. 6 illustrates an example of a block diagram 600 of a device 602 that supports the use of bandwidth parts to reduce leakage of transmit power from a transmitter into a receiver of the device 602. Reduced leakage of transmit power reduces interference with the at least one receiver in accordance with aspects of the present disclosure. In one or more embodiments, device 602 is further configured to select a transmit filter and location of a local oscillator in order to reduce receiver desensing at the device 602. The device 602 may be an example of a UE 104 as described herein. The device 602 may support wireless communication with one or more base nodes 102, UEs 104, or any combination thereof. The device 602 may include components for bi-directional communications including components for transmitting and receiving communications, such as a communications manager 604, a processor 606, a memory 608, a receiver 610, transmitter 612, and an I/O controller 614. These components may be in electronic communication or otherwise coupled (e.g., operatively, communicatively, functionally, electronically, electrically) via one or more interfaces (e.g., buses). While illustrated as separate components, receiver 610 and transmitter 612 can be collectively referred to a transceiver 615 that supports the communication of the device. In some implementations, both components are provided on a single physical transceiver component.

The communications manager 604, the receiver 610, the transmitter 612, or various combinations thereof or various components thereof may be examples of means for performing various aspects of the present disclosure as described herein. For example, the communications manager 604, the receiver 610, the transmitter 612, or various combinations or components thereof may support a method for performing one or more of the functions described herein.

In some implementations, the communications manager 604, the receiver 610, the transmitter 612, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 606 and the memory 608 coupled with the processor 606 may be configured to perform one or more of the functions described herein (e.g., by executing, by the processor 606, instructions stored in the memory 608).

Additionally, or alternatively, in some implementations, the communications manager 604, the receiver 610, the transmitter 612, or various combinations or components thereof may be implemented in code (e.g., as communications management software or firmware) executed by the processor 606. If implemented in code executed by the processor 606, the functions of the communications manager 604, the receiver 610, the transmitter 612, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 604 may be configured to perform various operations (e.g., receiving, monitoring, transmitting) using or otherwise in cooperation with the receiver 610, the transmitter 612, or both. For example, the communications manager 604 may receive information from the receiver 610, send information to the transmitter 612, or be integrated in combination with the receiver 610, the transmitter 612, or both to receive information, transmit information, or perform various other operations as described herein. Although the communications manager 604 is illustrated as a separate component, in some implementations, one or more functions described with reference to the communications manager 604 may be supported by or performed by the processor 606, the memory 608, or any combination thereof. For example, the memory 608 may store code, which may include instructions executable by the processor 606 to cause the device 602 to perform various aspects of the present disclosure as described herein, or the processor 606 and the memory 608 may be otherwise configured to perform or support such operations.

For example, the communications manager 604 may support wireless communication at a first device (e.g., the device 602) in accordance with examples as disclosed herein. The communications manager 604 may be configured as or otherwise support a means for configuring modulator 622, baseband transmitter. The communication manager 604 receives configuration data for configuring a transmit carrier bandwidth into multiple bandwidth parts. The communication manager 604 selects a first bandwidth part from among the multiple bandwidth parts for use during uplink transmission. The communication manager 604 configures the transceiver 615 to use the first bandwidth part for uplink transmission, in order to reduce leakage of transmit power from the at least one transmitter 612 into the at least one receiver 610, and to reduce interference with the at least one receiver 610.

In one or more embodiments, in selecting the first bandwidth part, the communication manager 604 selects from among the more than one bandwidth part, a bandwidth part that is closer to a receive spectrum than other bandwidth parts, but has a smaller bandwidth relative to other bandwidth parts with larger bandwidths, in order to reduce receiver interference.

In one or more embodiments, the communication manager 604 selects a transmit filter 626 having a smaller bandwidth than the transmit carrier bandwidth; and configures the transceiver 615 to transmit using the first bandwidth part and the selected, smaller bandwidth, transmit filter. In one or more particular embodiments, in selecting the transmit filter 626, the communication manager 604 selects the transmit filter 626 corresponding to a smallest carrier bandwidth that contains the first bandwidth part.

In one or more embodiments, the communication manager 604 reduces a bandwidth of the selected transmit filter to an operational bandwidth that is less than a transmit carrier bandwidth and greater than a first bandwidth part bandwidth, to reduce the interference with the at least one receiver.

In one or more embodiments, the communication manager 604 places the selected transmit filter 626 at a filter location relative to the first bandwidth part, such that a bandwidth of the selected transmit filter 626 encompasses a complete bandwidth of the bandwidth part when the selected transmit filter 626 is at the filter location. The filter location is selected from among: (i) a first filter location centered on the first bandwidth part; (ii) a second filter location centered on a local oscillator within the first bandwidth part; and (iii) a third filter location that is shifted such that an edge of the selected transmit filter is at a furthest distance away from a receive spectrum while still encompassing the first bandwidth part.

In one or more embodiments, the communication manager 604 configures the transceiver 715 to move an oscillator location of a local oscillator of the at least one transmitter 712 to within the first bandwidth part to reduce a span of resulting intermodulation products due to transmitter nonlinearities and to reduce interference to the at least one receiver 710. In one or more particular embodiments, the communication manager 604 configures the transceiver 615 to center the oscillator location of the local oscillator within the first bandwidth part.

In one or more embodiments, the device 602 transmits device capability data to a base node 102 (FIG. 1) to which the device 602 is communicatively connected via the transceiver 715. The device capability data identifying a capability to configure the transmit carrier of the device 602 into the more than one bandwidth part. The device 602 receives the configuration data within a control signal from the base node 102 (FIG. 1). The configuration data includes bandwidth size and relative location of each of the more than one bandwidth part. In one or more particular embodiments, the device 602 provides within the device capability data transmitted to the base node at least one of a second capability to place a local oscillator in an oscillator location within the bandwidth part and a third capability to reduce a bandwidth of a transmit filter when transmitting the bandwidth part, and a fourth capability to shift a filter location relative to the bandwidth part. In response to receiving instructions within the configuration data to adjust the oscillator location to within the first bandwidth part, the communication manager 604 triggers the transceiver 615 to adjust the oscillator location. In response to receiving instructions within the configuration data to modify one of a width and a filter location of an identified transmit filter, the communication manager 604 selects the identified transmit filter 626 and performs a corresponding modification of the selected transmit filter 626.

The processor 606 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 606 may be configured to operate a memory array using a memory controller. In some other implementations, a memory controller may be integrated into the processor 606. The processor 606 may be configured to execute computer-readable instructions stored in a memory (e.g., the memory 608) to cause the device 602 to perform various functions of the present disclosure.

The memory 608 may include random access memory (RAM) and read-only memory (ROM). The memory 608 may store computer-readable, computer-executable code including instructions that, when executed by the processor 606 cause the device 602 to perform various functions described herein. The code may be stored in a non-transitory computer-readable medium such as system memory or another type of memory. In some implementations, the code may not be directly executable by the processor 606 but may cause a computer (e.g., when compiled and executed) to perform functions described herein. In some implementations, the memory 608 may include, among other things, a basic I/O system (BIOS) which may control basic hardware or software operation such as the interaction with peripheral components or devices.

The I/O controller 614 may manage input and output signals for the device 602. The I/O controller 614 may also manage peripherals not integrated into the device 602. In some implementations, the T/O controller 614 may represent a physical connection or port to an external peripheral. In some implementations, the I/O controller 614 may utilize an operating system such as iOS®, ANDROID®, MS-DOS®, MS-WINDOWS®, OS/2®, UNIX®, LINUX®, or another known operating system. In some implementations, the I/O controller 614 may be implemented as part of a processor, such as the processor 606. In some implementations, a user may interact with the device 602 via the I/O controller 614 or via hardware components controlled by the I/O controller 614.

In some implementations, the device 602 may include a single antenna 616. However, in some other implementations, the device 602 may have more than one antenna 616, which may be capable of concurrently transmitting or receiving multiple wireless transmissions. The receiver 610 and the transmitter 612 may communicate bi-directionally, via the one or more antennas 616, wired, or wireless links as described herein. For example, the receiver 610 and the transmitter 612 may represent a wireless transceiver and may communicate bi-directionally with another wireless transceiver. The transceiver may also include a modem to modulate the packets, to provide the modulated packets to one or more antennas 616 for transmission, and to demodulate packets received from the one or more antennas 616.

According to aspects of the present disclosure, the receiver 610 and transmitter 612 are communicatively coupled to the antenna 616 by a duplex filter 618 as part of a transceiver 615 that supports FDD wireless communication. A modulator 622 performs modulation such as using Orthogonal Frequency Division Modulation (OFDM) or Discrete Fourier Transform-spread (DFT-s) OFDM on a received baseband signal from data source 624, such as stored in memory 608. Bandwidth of the modulated baseband signal from modulator 622 is reduced by communication manager 604 selecting an appropriate baseband transmitter filter (“transmit filter”) 626 with the filtered signal passing to the transmitter 612.

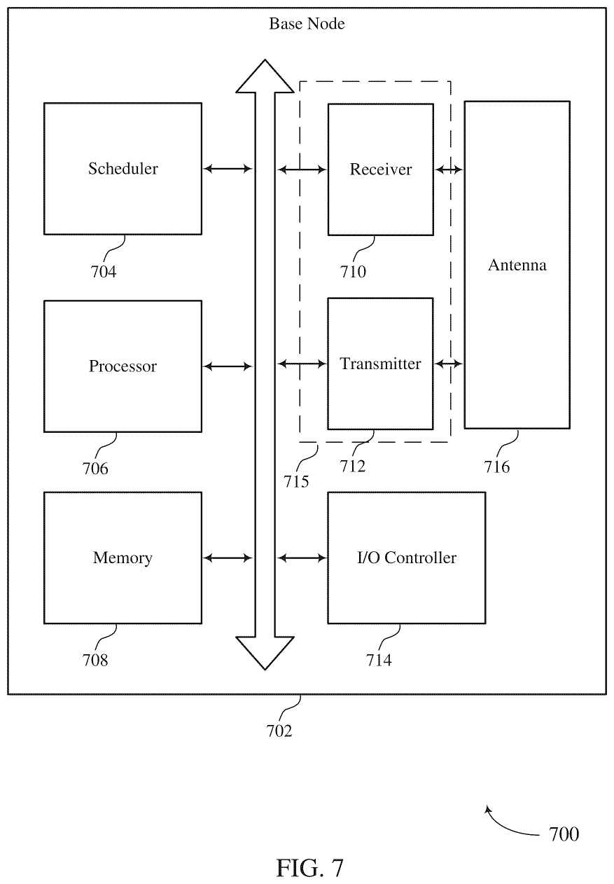

FIG. 7 illustrates an example of a block diagram 700 of a network device 702 that supports reducing receiver interference at a user communication device, such as UE 104 described above, by configuring UE 104 with bandwidth parts, and enabling selection of a transmit filter, and location of a local oscillator in order to reduce receiver desensing at the user communication device in accordance with aspects of the present disclosure. The device 702 may be an example of a base node 102 as described herein. The device 702 may support wireless communication with one or more base nodes 102, UEs 104, or any combination thereof. The device 702 may include components for bi-directional communications including components for transmitting and receiving communications, such as a scheduler 704, a processor 706, a memory 708, a receiver 710, transmitter 712, and an I/O controller 714. A combination of the receiver 710 and transmitter 712 is referred to as a transceiver 715. These components may be in electronic communication or otherwise coupled (e.g., operatively, communicatively, functionally, electronically, electrically) via one or more interfaces (e.g., buses).

The scheduler 704, the receiver 710, the transmitter 712, or various combinations thereof or various components thereof may be examples of means for performing various aspects of the present disclosure as described herein. For example, the scheduler 704, the receiver 710, the transmitter 712, or various combinations or components thereof may support a method for performing one or more of the functions described herein.

In some implementations, the scheduler 704, the receiver 710, the transmitter 712, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 706 and the memory 708 coupled with the processor 706 may be configured to perform one or more of the functions described herein (e.g., by executing, by the processor 706, instructions stored in the memory 708).

Additionally, or alternatively, in some implementations, the scheduler 704, the receiver 710, the transmitter 712, or various combinations or components thereof may be implemented in code (e.g., as communications management software or firmware) executed by the processor 706. If implemented in code executed by the processor 706, the functions of the scheduler 704, the receiver 710, the transmitter 712, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some implementations, the scheduler 704 may be configured to perform various operations (e.g., receiving, monitoring, transmitting) using or otherwise in cooperation with the receiver 710, the transmitter 712, or both. For example, the scheduler 704 may receive information from the receiver 710, send information to the transmitter 712, or be integrated in combination with the receiver 710, the transmitter 712, or both to receive information, transmit information, or perform various other operations as described herein. Although the scheduler 704 is illustrated as a separate component, in some implementations, one or more functions described with reference to the scheduler 704 may be supported by or performed by the processor 706, the memory 708, or any combination thereof. For example, the memory 708 may store code, which may include instructions executable by the processor 706 to cause the device 702 to perform various aspects of the present disclosure as described herein, or the processor 706 and the memory 708 may be otherwise configured to perform or support such operations.

For example, the scheduler 704 may support wireless communication at a first device (e.g., the device 702) in accordance with examples as disclosed herein. The scheduler 704 may be configured as or otherwise support enhancing receiver sensitivity at a user communication device. The scheduler 704 receives bandwidth part capability data from a communication device such as UE 104 (FIG. 2). The scheduler 704 may determine, in response to receiving the bandwidth part capability data, at least one first bandwidth part having a bandwidth and a location within a transmit carrier bandwidth that reduces interference from a transmitter of the communication device into a receiver of the communication device. The scheduler encodes a configuration signal with an assignment of bandwidth parts to the communication device in order to reduce receiver desensing from interference caused by a transmitter power. The scheduler transmits, by the transceiver 715, the configuration signal to the communication device to cause the communication device to configure the bandwidth parts on the transmit carrier bandwidth and select the first bandwidth part for transmissions to reduce the receiver desensing.

In one or more embodiments, in response to detecting a connection by the user communication device, the scheduler 704 may determine to implement an enhanced receiver sensitivity configuration at the user communication device. The scheduler 704 autonomously transmits, by the transceiver 715, a configuration signal to the communication device to configure the user communication device to: (i) configure bandwidth parts on a transmit carrier bandwidth of the transmit carrier; (ii) select a first bandwidth part and a transmit filter for transmissions via the first bandwidth part in order to reduce receiver desensing at the user communication device; and (iii) select a location of one or both of a local oscillator and the transmit filter if the communication device supports modification of the location.

The processor 706 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 706 may be configured to operate a memory array using a memory controller. In some other implementations, a memory controller may be integrated into the processor 706. The processor 706 may be configured to execute computer-readable instructions stored in a memory (e.g., the memory 708) to cause the device 702 to perform various functions of the present disclosure.

The memory 708 may include random access memory (RAM) and read-only memory (ROM). The memory 708 may store computer-readable, computer-executable code including instructions that, when executed by the processor 706 cause the device 702 to perform various functions described herein. The code may be stored in a non-transitory computer-readable medium such as system memory or another type of memory. In some implementations, the code may not be directly executable by the processor 706 but may cause a computer (e.g., when compiled and executed) to perform functions described herein. In some implementations, the memory 708 may include, among other things, a basic I/O system (BIOS) which may control basic hardware or software operation such as the interaction with peripheral components or devices.

The I/O controller 714 may manage input and output signals for the device 702. The I/O controller 714 may also manage peripherals not integrated into the device 702. In some implementations, the I/O controller 714 may represent a physical connection or port to an external peripheral. In some implementations, the I/O controller 714 may utilize an operating system such as iOS®, ANDROID®, MS-DOS®, MS-WINDOWS®, OS/2®, UNIX®, LINUX®, or another known operating system. In some implementations, the I/O controller 714 may be implemented as part of a processor, such as the processor 706. In some implementations, a user may interact with the device 702 via the I/O controller 714 or via hardware components controlled by the I/O controller 714.

In some implementations, the device 702 may include a single antenna 716. However, in some other implementations, the device 702 may have more than one antenna 716, which may be capable of concurrently transmitting or receiving multiple wireless transmissions. The receiver 710 and the transmitter 712 may communicate bi-directionally, via the one or more antennas 716, wired, or wireless links as described herein. For example, the receiver 710 and the transmitter 712 may represent a wireless transceiver and may communicate bi-directionally with another wireless transceiver. The transceiver may also include a modem to modulate the packets, to provide the modulated packets to one or more antennas 716 for transmission, and to demodulate packets received from the one or more antennas 716.

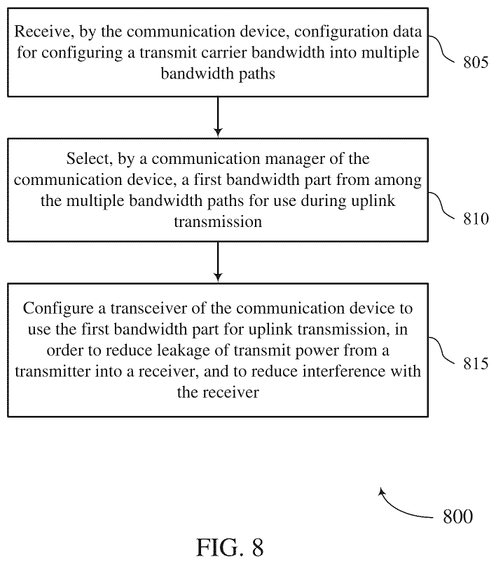

FIG. 8 illustrates a flowchart of a method 800 that supports wireless communication using bandwidth parts in order to avoid receiver desensitization due to transmitter noise for frequency division duplex bands in accordance with aspects of the present disclosure. The operations of the method 800 may be implemented by a device or its components as described herein. For example, the operations of the method 800 may be performed by UE 114 as described with reference to FIGS. 1 and 5. In some implementations, the device may execute a set of instructions to control the function elements of the device to perform the described functions. Additionally, or alternatively, the device may perform aspects of the described functions using special-purpose hardware.

At 805, the method 800 may include receiving, by the communication device, configuration data for configuring a transmit carrier bandwidth into multiple bandwidth parts. The operations of 805 may be performed in accordance with examples as described herein. In some implementations, aspects of the operations of 805 may be performed by a device as described with reference to FIG. 1.

At 810, the method 800 may include selecting, by a communication manager of the communication device, a first bandwidth part from among the multiple bandwidth parts for use during uplink transmission. The operations of 810 may be performed in accordance with examples as described herein. In some implementations, aspects of the operations of 810 may be performed by a device as described with reference to FIG. 1.

At 815, the method 800 may include configuring a transceiver of the communication device to use the first bandwidth part for uplink transmission, in order to reduce leakage of transmit power from a transmitter into a receiver, and to reduce interference with the receiver The operations of 815 may be performed in accordance with examples as described herein. In some implementations, aspects of the operations of 815 may be performed by a device as described with reference to FIG. 1.

In one or more embodiments, the method 800 includes selecting the first bandwidth part by selecting from among the multiple bandwidth parts, a bandwidth part that is closer to a receive spectrum than other bandwidth parts but has a smaller bandwidth relative to other bandwidth parts with larger bandwidths, in order to reduce receiver interference.

In one or more embodiments, the method 800 includes selecting a transmit filter having a smaller bandwidth than the transmit carrier bandwidth. Method 800 includes configuring the transceiver to transmit using the first bandwidth part and the selected, smaller bandwidth, transmit filter. In one or more particular embodiments, the method 800 includes selecting the transmit filter by selecting the transmit filter corresponding to a smallest allowed carrier bandwidth that contains the first bandwidth part.

In one or more embodiments, the method 800 includes reducing a bandwidth of the selected transmit filter to an operational bandwidth that is less than a transmit carrier bandwidth and greater than a first bandwidth part bandwidth, to reduce the interference with the receiver.

In one or more embodiments, the method 800 includes selecting a filter location from among: (i) a first filter location centered on the first bandwidth part; (ii) a second filter location centered on a local oscillator within the first bandwidth part; and (iii) a third filter location that is shifted such that an edge of the selected transmit filter is at a furthest distance away from a receive spectrum while still encompassing the first bandwidth part. The method 800 includes placing the selected transmit filter at the filter location relative to the first bandwidth part, such that a bandwidth of the selected transmit filter encompasses a complete bandwidth of the bandwidth part when the selected transmit filter is at the filter location.

In one or more embodiments, the method 800 includes configuring the transceiver to move an oscillator location of a local oscillator of the transmitter to within the first bandwidth part to reduce a span of resulting intermodulation products and to reduce interference to the receiver. In one or more particular embodiments, method 800 includes configuring the transceiver to center the oscillator location of the local oscillator within the first bandwidth part.

In one or more embodiments, the method 800 includes transmitting device capability data to a base node to which the device is communicatively connected via the transceiver. The device capability data identifies a capability to configure the transmit carrier of the device into the multiple bandwidth parts. The method 800 includes receiving the configuration data within a control signal from the base node, the configuration data comprising bandwidth size and relative location of each of the multiple bandwidth parts.

In one or more particular embodiments, the method 800 includes providing within the device capability data transmitted to the base node at least one of a second capability to place a local oscillator in an oscillator location within the bandwidth part and a third capability to reduce a bandwidth of a transmit filter when transmitting the bandwidth part, and a fourth capability to shift a filter location relative to the bandwidth part. In response to receiving instructions within the configuration data to adjust the oscillator location to within the first bandwidth part, the method 800 includes triggering the transceiver to adjust the oscillator location. In response to receiving instructions within the configuration data to modify one of a width and a filter location of an identified transmit filter, the method 800 includes selecting the identified transmit filter and perform a corresponding modification of the selected transmit filter.

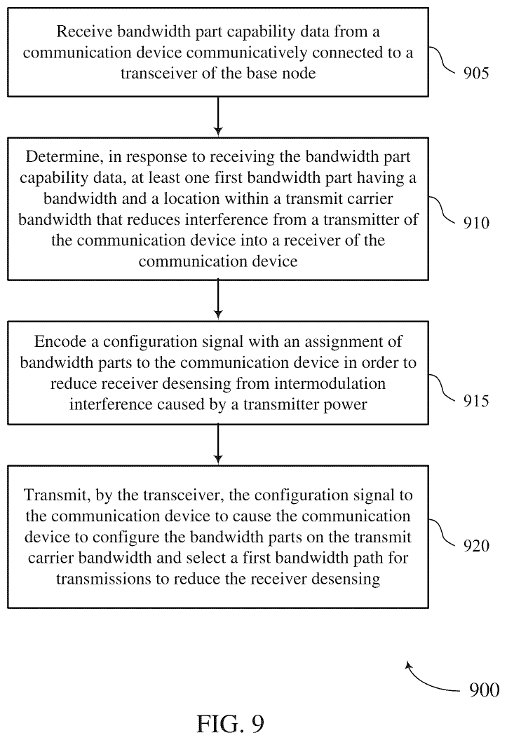

FIG. 9 illustrates a flowchart of a method 900 that supports wireless communication by a communication device that reduces leakage of transmit power from a transmitter into a receiver of the communication device to reduce interference with the receiver in accordance with aspects of the present disclosure. The operations of the method 900 may be implemented by a device or its components as described herein. For example, the operations of the method 900 may be performed by base node 102 as described with reference to FIGS. 1 and 5. In some implementations, the device may execute a set of instructions to control the function elements of the device to perform the described functions. Additionally, or alternatively, the device may perform aspects of the described functions using special-purpose hardware.

At 905, the method may include receiving bandwidth part capability data from a communication device communicatively connected to a transceiver of the base node. The operations of 905 may be performed in accordance with examples as described herein. In some implementations, aspects of the operations of 905 may be performed by a device as described with reference to FIG. 1.

At 910, the method may include determining, in response to receiving the bandwidth part capability data, at least one first bandwidth part having a bandwidth and a location within a transmit carrier bandwidth that reduces interference from a transmitter of the communication device into a receiver of the communication device. The operations of 910 may be performed in accordance with examples as described herein. In some implementations, aspects of the operations of 910 may be performed by a device as described with reference to FIG. 1.

At 915, the method may include encoding a configuration signal with an assignment of bandwidth parts to the communication device in order to reduce receiver desensing from interference caused by a transmitter power. The operations of 915 may be performed in accordance with examples as described herein. In some implementations, aspects of the operations of 915 may be performed by a device as described with reference to FIG. 1.

At 920, the method may include transmitting, by the transceiver, the configuration signal to the communication device to cause the communication device to configure the bandwidth parts on the transmit carrier bandwidth and select a first bandwidth part for transmissions to reduce the receiver desensing. The operations of 920 may be performed in accordance with examples as described herein. In some implementations, aspects of the operations of 920 may be performed by a device as described with reference to FIG. 1.

In one or more embodiments, the method 900 includes identifying that the capability data includes a capability of the communication device to select a transmit filter from among more than one transmit filters provided by the communication device and to modify a bandwidth and a filter location of the selected transmit filter. The method 900 includes encoding, within the configuration signal, control commands to configure the communication device to (i) select a transmit filter with a transmit filter bandwidth that is less than a transmit carrier bandwidth and that encompasses the bandwidth part; (ii) selectively reduce the transmit filter bandwidth to a smallest allowed carrier bandwidth that contains the first bandwidth part; (iii) move a location of the transmit filter to a filter location in which the transmit filter bandwidth includes a complete bandwidth part bandwidth.

In one or more embodiments, the method 900 includes identifying that the capability data includes a capability of the communication device to place a local oscillator within the first bandwidth part. The method 900 includes encoding, within the configuration signal, commands to configure the communication device to place the local oscillator within the bandwidth part.

In one or more embodiments, the method 900 includes selecting, as the first bandwidth part, a bandwidth part having a bandwidth and a location within the transmit carrier bandwidth for which an interference from the transmitter of the communication device into the receiver of the communication device is minimal, in order to protect the receiver when the communication device is transmitting at full power.

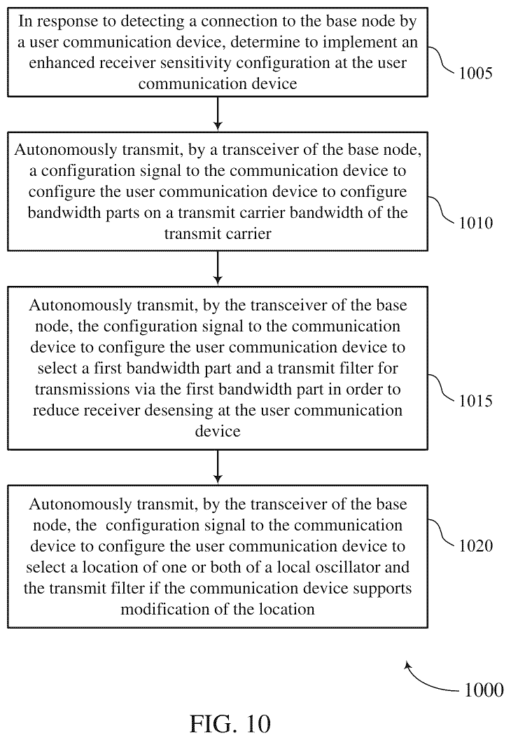

FIG. 10 illustrates a flowchart of a method 1000 that supports wireless communication between a user communication device and a network device in accordance with aspects of the present disclosure. The network device implements bandwidth part allocation and support at the user communication device in order to reduce receiver desensing at the user communication device. The operations of the method 1000 may be implemented by a device or its components as described herein. For example, the operations of the method 1000 may be performed by a base node 102 as described with reference to FIGS. 1 and 6. In some implementations, the device may execute a set of instructions to control the function elements of the device to perform the described functions. Additionally, or alternatively, the device may perform aspects of the described functions using special-purpose hardware.

At 1005, the method may include in response to detecting a connection to the base node by a user communication device, determining to implement an enhanced receiver sensitivity configuration at the user communication device. The operations of 1005 may be performed in accordance with examples as described herein. In some implementations, aspects of the operations of 1005 may be performed by a device as described with reference to FIG. 1.

At 1010, the method may include autonomously transmitting, by a transceiver of the base node, a configuration signal to the communication device to configure the user communication device to configure bandwidth parts on a transmit carrier bandwidth of the transmit carrier. The operations of 1010 may be performed in accordance with examples as described herein. In some implementations, aspects of the operations of 1010 may be performed by a device as described with reference to FIG. 1.

At 1015, the method may include autonomously transmitting, by the transceiver of the base node, the configuration signal to the communication device to configure the user communication device to select a first bandwidth part and a transmit filter for transmissions via the first bandwidth part in order to reduce receiver desensing at the user communication device. The operations of 1015 may be performed in accordance with examples as described herein. In some implementations, aspects of the operations of 1015 may be performed by a device as described with reference to FIG. 1.

At 1020, the method may include autonomously transmitting, by the transceiver of the base node, the configuration signal to the communication device to configure the user communication device to select a location of one or both of a local oscillator and the transmit filter if the communication device supports modification of the location. The operations of 1020 may be performed in accordance with examples as described herein. In some implementations, aspects of the operations of 1020 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, the UE comprising:
a transceiver comprising at least one transmitter, at least one receiver, and more than one transmit filters;
a memory; and
a processor communicatively coupled to the memory and to the transceiver, and which is configured to cause the UE to:
receive configuration data for configuring a transmit carrier bandwidth into multiple bandwidth parts;
select a first bandwidth part from among the multiple bandwidth parts for use during uplink transmission; and
configure the transceiver to use the first bandwidth part for uplink transmission, in order to reduce leakage of transmit power from the at least one transmitter into the at least one receiver, and to reduce interference with the at least one receiver.

2. The UE of claim 1, wherein in selecting the first bandwidth part, the processor further causes the UE to select from among the more than one bandwidth part, a bandwidth part that is closer to a receive spectrum than other bandwidth parts, but has a smaller bandwidth relative to other bandwidth parts with larger bandwidths, in order to reduce receiver interference.

3. The UE of claim 1, wherein the processor further causes the UE to:
select a transmit filter having a smaller bandwidth than the transmit carrier bandwidth; and
configure the transceiver to transmit using the first bandwidth part and the selected, smaller bandwidth, transmit filter.

4. The UE of claim 3, wherein in selecting the transmit filter the processor further causes the UE to select the transmit filter corresponding to a smallest carrier bandwidth that contains the first bandwidth part.

5. The UE of claim 3, wherein the processor further causes the UE to:
reduce a bandwidth of the selected transmit filter to an operational bandwidth that is less than a transmit carrier bandwidth and greater than a first bandwidth part bandwidth, to reduce the interference with the at least one receiver.

6. The UE of claim 1, wherein the processor further causes the UE to place the selected transmit filter at a filter location relative to the first bandwidth part, such that a bandwidth of the selected transmit filter encompasses a complete bandwidth of the bandwidth part when the selected transmit filter is at the filter location, and wherein the filter location is selected from among:
a first filter location centered on the first bandwidth part;
a second filter location centered on a local oscillator within the first bandwidth part; and
a third filter location that is shifted such that an edge of the selected transmit filter is at a furthest distance away from a receive spectrum while still encompassing the first bandwidth part.

7. The UE of claim 1, wherein the processor configures the transceiver to move an oscillator location of a local oscillator of the at least one transmitter to within the first bandwidth part to reduce a span of resulting intermodulation products and to reduce interference to the at least one receiver.

8. The UE of claim 7, wherein the processor configures the transceiver to center the oscillator location of the local oscillator within the first bandwidth part.

9. The UE of claim 1, wherein the processor further causes the UE to:
transmit device capability data to a base node to which the device is communicatively connected via the transceiver, the device capability data identifying a capability to configure the transmit carrier of the device into the more than one bandwidth part; and
receive the configuration data within a control signal from the base node, the configuration data comprising bandwidth size and relative location of each of the more than one bandwidth part.

10. The UE of claim 9, wherein the processor further causes the UE to:
provide within the device capability data transmitted to the base node at least one of a second capability to place a local oscillator in an oscillator location within the bandwidth part and a third capability to reduce a bandwidth of a transmit filter when transmitting the bandwidth part, and a fourth capability to shift a filter location relative to the bandwidth part;
in response to receiving instructions within the configuration data to adjust the oscillator location to within the first bandwidth part, trigger the transceiver to adjust the oscillator location; and
in response to receiving instructions within the configuration data to modify one of a width and a filter location of an identified transmit filter, select the identified transmit filter and performs a corresponding modification of the selected transmit filter.

11. A base node for wireless communication, the base node comprising:
a transceiver that receives a bandwidth part capability data from a user equipment (UE) communicatively connected to the base node via the transceiver; and
a scheduler communicatively coupled to the transceiver, and which causes the base node to:
determine, in response to receiving the bandwidth part capability data, at least one first bandwidth part having a bandwidth and a location within a transmit carrier bandwidth that reduces interference from a transmitter of the UE into a receiver of the UE;
encode a configuration signal with an assignment of bandwidth parts to the UE in order to reduce receiver desensing from interference caused by a transmitter power; and
transmit, by the transceiver, the configuration signal to the UE to cause the UE to configure the bandwidth parts on the transmit carrier bandwidth and select the first bandwidth part for transmissions to reduce the receiver desensing.

12. The base node of claim 11, wherein the scheduler causes the base node to:
identify that the capability data includes a capability of the UE to select a transmit filter from among more than one transmit filter provided by the UE and to modify a bandwidth and a filter location of the selected transmit filter; and
encode, within the configuration signal, commands to configure the UE to (i) select a transmit filter with a transmit filter bandwidth that is less than a transmit carrier bandwidth and that encompasses the first bandwidth part; (ii) selectively reduce the transmit filter bandwidth to a smallest allowed carrier bandwidth that contains the first bandwidth part; (iii) move a location of the transmit filter to a filter location in which the transmit filter bandwidth includes a complete bandwidth part bandwidth.

13. The base node of claim 11, wherein the scheduler causes the base node to:
identify that the capability data includes a capability of the UE to place a local oscillator within the first bandwidth part; and
encode, within the configuration signal, commands to configure the UE to place the local oscillator within the bandwidth part.

14. The base node of claim 11, wherein the scheduler causes the base node to:
select, as the first bandwidth part, a bandwidth part having a bandwidth and a location within the transmit carrier bandwidth for which an interference from the transmitter of the UE into the receiver of the UE is minimal, in order to protect the receiver when the UE is transmitting at full power.

15. A base node for wireless communication, the base node comprising:
a transceiver that communicatively connects to a user equipment (UE); and
a scheduler communicatively coupled to the transceiver, and which:
in response to detecting a connection by the UE:
determines to implement an enhanced receiver sensitivity configuration at the UE; and
autonomously transmits, by the transceiver, a configuration signal to the UE to configure the UE to:
configure bandwidth parts on a transmit carrier bandwidth of the transmit carrier;
select a first bandwidth part and a transmit filter for transmissions via the first bandwidth part in order to reduce receiver desensing at the UE; and
select a location of one or both of a local oscillator and the transmit filter if the UE supports modification of the location.

16. The base node of claim 15, wherein the configuration signal further configures the UE to:
select as the transmit filter a small bandwidth transmit filter having a transmit filter bandwidth that is less than a transmit carrier bandwidth and that encompasses the bandwidth part; and
selectively reduce the transmit filter bandwidth to a smallest allowed carrier bandwidth that contains the bandwidth part.

17. A method for wireless communication by a user equipment (UE), the method comprising:
receiving, via a transceiver of the UE, configuration data for configuring a transmit carrier bandwidth into multiple bandwidth parts, the transceiver comprising at least one transmitter, at least one receiver;
selecting a first bandwidth part from among the multiple bandwidth parts for use during uplink transmission; and
configuring the transceiver to use the first bandwidth part for uplink transmission, in order to reduce leakage of transmit power from the at least one transmitter into the at least one receiver, and to reduce interference with the at least one receiver.

18. The method of claim 17, wherein selecting the first bandwidth part comprises selecting, from among the more than one bandwidth part, a bandwidth part that is closer to a receive spectrum than other bandwidth parts, but has a smaller bandwidth relative to other bandwidth parts with larger bandwidths, in order to reduce receiver interference.

19. The method of claim 17, wherein the transceiver comprises more than one transmit filters, and the method further comprises:
selecting a transmit filter having a smaller bandwidth than the transmit carrier bandwidth and corresponding to a smallest carrier bandwidth that contains the first bandwidth part; and
configuring the transceiver to transmit using the first bandwidth part and the selected, smaller bandwidth, transmit filter, by reducing a bandwidth of the selected transmit filter to an operational bandwidth that is less than a transmit carrier bandwidth and greater than a first bandwidth part bandwidth, to reduce the interference with the at least one receiver.

20. The method of claim 17, further comprising:
transmitting device capability data to a base node to which the device is communicatively connected via the transceiver, the device capability date comprising a first device capability data identifying a capability to configure the transmit carrier of the device into the more than one bandwidth part and at least one of a second capability to place a local oscillator in an oscillator location within the bandwidth part and a third capability to reduce a bandwidth of a transmit filter when transmitting the bandwidth part, and a fourth capability to shift a filter location relative to the bandwidth part;
receiving the configuration data within a control signal from the base node, the configuration data comprising bandwidth size and relative location of each of the more than one bandwidth part;
in response to receiving instructions within the configuration data to adjust the oscillator location to within the first bandwidth part, triggering the transceiver to adjust the oscillator location; and
in response to receiving instructions within the configuration data to modify one of a width and a filter location of an identified transmit filter, selecting the identified transmit filter and performs a corresponding modification of the selected transmit filter.
